(19) United States
(12) Patent Application Publication
(10) Pub. No.: US 2022/0253757 A1
(43) Pub. Date: Aug. 11, 2022

(54) METAHEURISTICS OPTIMIZER FOR CONTROLLED ENVIRONMENT AGRICULTURE

(71) Applicants: Vincent Harkiewicz, Yorba Linda, CA (US); Cristian Mendoza, Westminster, CO (US)

(72) Inventors: Vincent Harkiewicz, Yorba Linda, CA (US); Cristian Mendoza, Westminster, CO (US)

(73) Assignee: Grownetics, Inc., Boulder, CO (US)

(21) Appl. No.: 17/650,246

(22) Filed: Feb. 7, 2022

Related U.S. Application Data
(60) Provisional application No. 63/146,580, filed on Feb. 6, 2021.

(51) Int. Cl. G06Q 10/04; A01G 9/26

(52) U.S. Cl. CPC G06Q 10/04; A01G 9/249; A01G 9/26

(57) ABSTRACT

A system for achieving optimized crop growth. A growth chamber is provided, as is environmental monitoring means for acquiring and monitoring data regarding environmental conditions within the growth chamber. Resource control means controls resources applied to the growth chamber. A metaheuristics based optimizer system is coupled to the environmental monitoring means for analyzing and evaluating crop growth conditions within the growth chamber, structuring data associated with the crop growth conditions, learning from the structured data using a routine to learn from the output of different machine learning strategies, and generating metaheuristic recommendations to optimize crop growing inputs. Optimized crop growth means to achieve crop growth with minimum consumption of energy and nutrients while improving yield and quality. The metaheuristics based optimizer system recommends and controls resources in response to the crop growth information to achieve optimized plant growth, maximum yield, and minimized power consumption.

### RELATED PATENT APPLICATION

The present application is related to co-pending U.S. provisional patent application for DEEP LEARNING OPTIMIZER FOR CONTROLLED ENVIRONMENT AGRICULTURE, application No. 63/146,580, filed Feb. 6, 2021, the full disclosures of which are hereby incorporated by reference and priority which are hereby claimed.

### FIELD OF THE INVENTION

The present invention pertains to controlled environment agriculture and, more particularly, to a method for controlling crop growth using control system, resources, and yield or growth outcomes, for growth factor optimization to automatically and/or remotely monitor and control inputs for crop growth.

### BACKGROUND OF THE INVENTION

Currently, crop growing management, including management of irrigation and/or climate control, is an important part of agriculture and landscaping.

Water, lighting, and environmental requirements for crops fluctuate widely during the growth cycle, as a result of internal and external greenhouse or indoor grow facility conditions and variables. Variables such as rain, ambient temperature, relative humidity, light intensity, CO2 concentration, rain, wind speed, and crop need.

Three methods can be used to assess a crop's condition: visual, indirect, and direct. Visual observation is subjective and requires the grower to wait for physical signs of plant deterioration before adjusting the irrigation, lighting, or environmental control schedule. This waiting period causes the crop to experience significant and otherwise preventable stress. Methods of indirect measurement include temperature and humidity sensors, CO2 sensors, Quantum Light Sensors, soil moisture sensors, and/or calculation of evapotranspiration or atmospheric parameters. These techniques require considerable time, cost and effort and still fail to give a comprehensive assessment of the plant's needs. Direct measures such as measuring stomatal resistance or tissue sampling are costly and destructive to the plant.

There is also a need for the grower to access historical data of his crop water, photosynthetic active radiation (PAR/plant usable light) and canopy environment status as well as plant treatments. Farming has progressed to a highly technical science, where biological characteristics of the plant, environmental conditions, expected environmental forecasts and even such data as market changes, utility costs and water restriction laws must be considered to reach prudent watering, lighting, and environmental control decisions.

### DESCRIPTION OF RELATED ART

U.S. Pat. No. 7,987,632 issued to May, et al. on Aug. 2, 2011 for SYSTEM FOR CONTROLLING PLANT GROWTH IN A CONTAINED ENVIRONMENT describes a system for optimizing crop growth. Vegetation is cultivated in a contained environment, such as a greenhouse, an underground cavern or other enclosed space. Imaging equipment is positioned within or about the contained environment, to acquire spatially distributed crop growth information, and environmental sensors are provided to acquire data regarding multiple environmental conditions that can affect crop development. Illumination within the contained environment, and the addition of essential nutrients and chemicals are in turn controlled in response to data acquired by the imaging apparatus and environmental sensors, by an “system” which is trained to analyze and evaluate crop conditions. The system controls the spatial and temporal lighting pattern within the contained area, and the timing and allocation of nutrients and chemicals to achieve optimized crop development. A user can access the system remotely, to assess activity within the growth chamber, and can override the system. Environmental and atmospheric control is not explicitly described.

United States Published Patent Application No. 2012/0109387 on an application filed by Martin, et al., published on May 3, 2012 for REMOTE ANALYSIS AND CORRECTION OF CROP CONDITION describes a method, system and apparatus for early diagnosis and real time remote intervention of crop condition by correlating collected crop characteristics with known plant parameters, economic variables and algorithms to computer generate an irrigation decision, remotely execute the same, and notify the end user. Environmental control and lighting control are not explicitly described.

United States Published Patent Application No. 2007/0260400 on an application filed by Morag, et al. on Nov. 8, 2007 for COMPUTERIZED CROP GROWING MANAGEMENT SYSTEM AND METHOD describes a computerized method of crop growing management and a system thereof. The method comprises receiving operational data and/or derivatives thereof and field data and/or derivatives thereof related to one or more crop growing blocks, and processing at least part of the received data so as to define cross-related data among the received data and/or discrepancy thereof. The method further comprises displaying the results, for example as a bar chart comprising one or more bars representing time-phased activity durations related to at least part crop growing blocks. Control or recommendation method is not explicitly described.

Optimizing crop growth in a controlled environment is a uniquely changing problem as crop growth inputs affect interrelated growth factors (i.e., adding more light for photosynthesis will require additional cooling and CO2 to maintain optimal growth while simultaneously require more frequent watering and feeding due to the increased photosynthesis. The multi-dimensional problem of optimizing crop growth recipes is perfectly suited to a metaheuristics AI/ML strategy. Existing technologies only control a limited number of independent growth variables and do not take into account the multiplicity of influencing factors in crop growth. Existing controls, analytics, fertigation, and irrigation tools are not integrated. Thus, it would be advantageous to provide a system which can control all crop growth factors in a contained environment with little or no human intervention. It is important that such a system also be capable of optimizing crop growth in terms of crop yield, phytochemicals, growth time, and the consumption of energy, nutrients, and labor.

### SUMMARY OF THE INVENTION

Given sets of structured data related to controlled environment agriculture, a control system recommendation engine is provided, capable of discovering underlying correlation between the network of crop growth factors towards a guided ideal outcome such as maximum yield, nutritional value, or resource conservation. The inventive recommendation engine for controlled environment agriculture can optimize any number of automated, or manual inputs (including task scheduling) for any variety of crops.

In accordance with the present invention, a system is provided for achieving optimized crop growth. A growth chamber is provided, as is environmental, lighting, water, and nutrient monitoring. Resource control means controlling resources, including but not limited to, nutrients, water, CO2, energy consumption of lights and HVAC equipment, labor and other inputs applied to the growth chamber. A metaheuristics based optimizer system is coupled to the environmental monitoring and control platform for analyzing and evaluating crop growth conditions within the growth chamber, structuring data associated with the crop growth conditions, learning from the structured data using a variety of optimization routines, including but not limited to, Bayesian Optimization strategy, and N.E.A.T. ML (Neuroevolution of Augmenting Topologies) to learn from the output of optimization routine, and generating recommendations to control the water, tasks, illumination and environmental control means to achieve optimized crop growth and minimum consumption of resources. The metaheuristics based optimizer system controls resources in response to the crop growth information to achieve optimized plant growth, maximum yield, nutrient or phytochemical concentration, and minimized power consumption.

In certain instances, a hardware agnostic sensing and imaging platform coupled to a database and management interface capable of sending manual or optimized control and automation set points to a BACnet or a Modbus gateway.

The recommendation engine can be directed to optimize for any number of functions or resources such as yield, resource usage (time, energy, water, labor), environmental controls set points, and control logic. For example: Given historical temperatures, relative humidity, CO2, and harvest weight, for a multiple of plants from the same genetic variety, the metaheuristics based model can be used to discover ideal temperatures, relative humidity, and CO2 control set points over time that lead to maximum yield in that specific genetic variety.

The system takes into consideration the multitude of co-dependencies related to an outcome such as harvest weight, while simultaneously not requiring a predefined growth model.

One object of the invention, therefore, is to provide a system which optimizes crop yields, while minimizing consumption of inputs.

Another object of invention is to obtain optimized crop yields in a minimal time period.

A further object is to adapt the frequency and modulation of specific light to accelerate plant growth, provide uniform growth, and minimize energy requirements.

Still another object of the invention is to provide a method and apparatus for remediation of adverse crop growth conditions and optimization of crop yields per unit of remediation input, automatically, without requiring human intervention.

Yet another object of the invention is to provide a crop growth control system that can be manipulated remotely from the situs of crop growth.

These and other objects and advantages are achieved by the system for optimizing crop growth according to the invention in which vegetation or other biomass is cultivated in a contained environment, such as a greenhouse, an underground cavern or other enclosed space. In the system according to the invention, sensors are positioned within or about the contained environment, to acquire spatially distributed crop growth information. Environmental sensors are provided to acquire data regarding multiple environmental conditions that can affect crop development. Illumination within the contained environment, and the addition of essential nutrients and chemicals are in turn controlled in response to data acquired by the environmental sensors.

In order to achieve an optimal crop yield with little or no human intervention, canopy environment, root zone environment, illumination and the addition of nutrients and chemicals are controlled by a system trained to analyze and evaluate crop conditions, for example using a heuristic technique. The system controls the spatial and temporal lighting pattern within the contained area, as well as the timing and allocation of nutrients and chemicals to achieve optimized crop development.

The system according to the invention monitors plant growth and alerts a central control if plants deviate from the optimal conditions. Ideally, the system is also trained to recommend remediation once a problem has been identified. Real-time data collected from the various monitoring devices can be utilized by the system. These measurements include root zone EC, pH, as well as canopy environment oxygen and carbon dioxide levels, trace gases, temperature, and humidity and vapor pressure deficit. Aerosol monitoring is also performed to detect pathogens, molds, and fungi diseases.

According to another feature of the invention, the system can be accessed by a remote decision maker who is located at a substantial distance from the contained environment, via a communications channel, such as the Internet and the world wide web, for example. It is of course apparent that the sensors, lighting equipment, and nutrient input devices must be situated at the site of the contained environment. However, the system itself, and the remote decision maker can be situated anywhere, provided only that adequate communications are available. In this way, the remote decision maker can assess what is occurring inside the growth chamber, and he or she can also override the system to control any component within the growth chamber.

Illumination within the contained environment is targeted only to areas where vegetation exists, by means of a matrix of individually operable light sources that have selected wavelengths. In addition, when individual light sources are delivering light to targeted areas within the contained environment, the emitted light is modulated in a manner that increases the photosynthesis process, reducing the amount of time and energy needed for a plant to reach maturity.

The invention achieves the greatest plant production (yield) in the least amount of time (growing days), by providing the optimal environment to obtain accelerated photosynthesis and plant development. The daily operation of this plant growth system is efficient in terms of power requirements, nutrient expenses, requirements for gases and other inputs, because it provides only what the plant needs when the plant needs it. In essence uptake by the plant equals inputs to the growth chamber.

Other objects, advantages and novel features of the present invention will become apparent from the following detailed description of the invention when considered in conjunction with the accompanying drawings.

### BRIEF DESCRIPTION OF THE DRAWING

A complete understanding of the present invention may be obtained by reference to the accompanying drawing, when considered in conjunction with the subsequent detailed description, in which:

FIG. 1 is a block diagram which illustrates the environmental monitoring and control components of the optimized automated cultivation system according to the invention;

FIG. 2 is a schematic illustration of a plant growth chamber according to the invention;

FIG. 3 is a block diagram of the overall system according to the invention; and

FIG. 4 is a block diagram illustrating the inventive process; and

FIG. 5 is a schematic illustration of an example system architecture according to the invention.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

The invention is a system for achieving optimized crop growth. A growth chamber is provided, as is environmental monitoring means for acquiring and monitoring data regarding environmental conditions within the growth chamber. Resource control means controlling resources applied to the growth chamber. A metaheuristics based optimizer system is coupled to the environmental monitoring means for analyzing and evaluating crop growth conditions within the growth chamber, structuring data associated with the crop growth conditions, learning from the structured data using a variety of machine learning, heuristics, and optimization routines to learn from the output of historical crop growth conditions, yields, and quality, and generating metaheuristic recommendations to optimize crop growing inputs, means to achieve optimized crop growth with minimum consumption of energy, labor, and resources while improving yield and quality. The metaheuristics based optimizer system recommends and controls resources in response to the crop growth information to achieve optimized plant growth, maximum yield, and minimized power consumption.

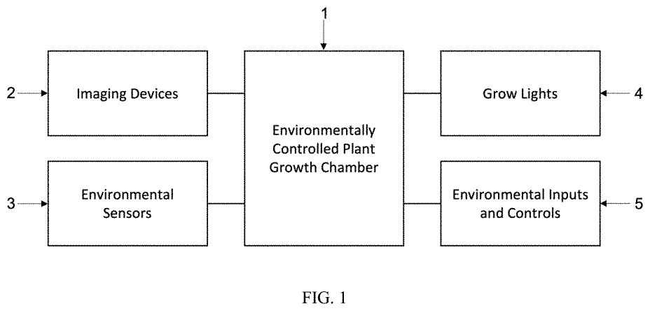

Referring now to the drawings, FIG. 1 is a conceptual block diagram which illustrates the various sensors and input devices which are used in conjunction with the environmentally controlled plant growth chamber 1. A suite of environmental sensors 3 is provided to detect environmental conditions within the plant growth chamber. Grow lights 4 are controlled in a manner described in greater detail hereinafter, and nutrients, chemicals and water are provided by the environmental inputs and controls 5.

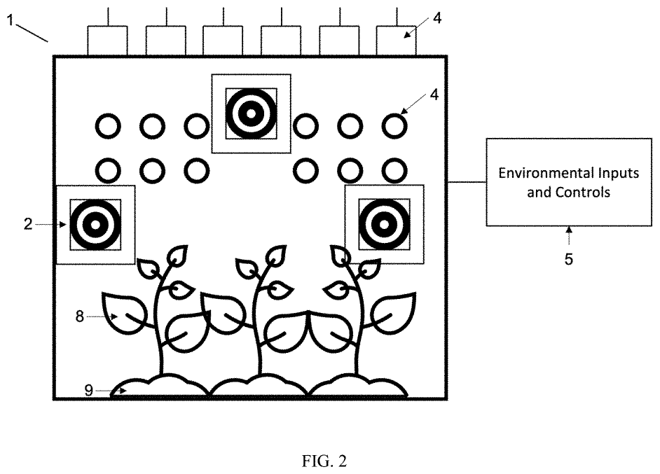

FIG. 2 is a schematic depiction of the plant growth chamber of FIG. 1, which shows the distribution of lights. In particular, a matrix of grow lights 4 is distributed over the surfaces of the growth chamber. (The matrix array of individual light sources 4 can be seen in FIG. 2 across the back side of the growth chamber 1. In addition, overhead lights are depicted schematically.) As noted previously, each of the individual light sources in the lighting matrix is individually operable in order to distribute light within the growth chamber in any desired manner, as discussed hereinafter.

Within the interior of the plant growth chamber, vegetation 8 is shown as growing in a growth medium 9. Sensors 2 are shown distributed over the surfaces of the growth chamber. Devices 5 for input of essential nutrients, chemicals and water are well known to those skilled in the art and are shown only schematically in FIG. 2.

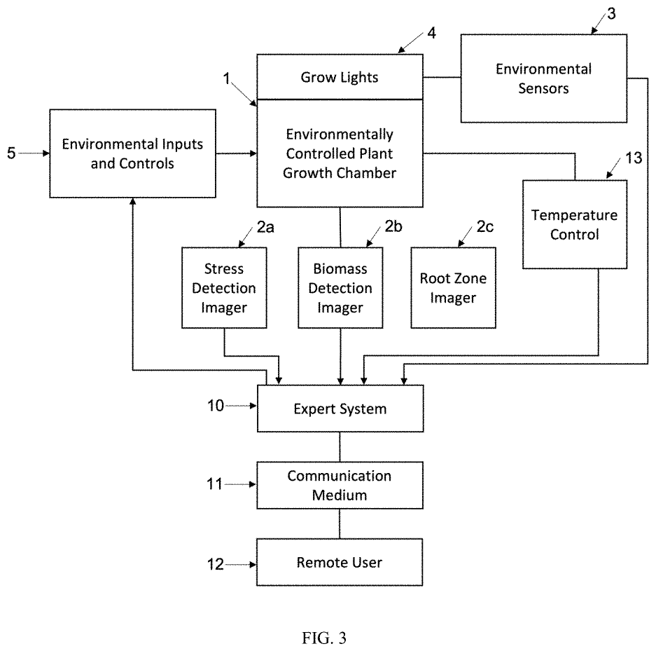

FIG. 3 is an overview of the entire plant growth system according to the invention, including the system referred to hereinabove. As can be seen, the system 10 is coupled to receive inputs from the environmental sensors 3.

The system 10, in turn, is connected to the environmental input device for injecting nutrients, chemicals and water into the plant growth chamber as needed. As will be understood by those skilled in the art, the input apparatus 5, which is shown schematically, includes devices for applying the various inputs according to a desired distribution pattern within the plant growth chamber, based on instructions from the system.

The system in turn communicates with a remote user 12 via a communications medium 11. Depending on the exact location of the plant growth chamber and system, various communications media may be appropriate. Via these communication channels, the remote user 12, can communicate with the system, which may ask for input information from the remote user prior to making a determination as to the input and distribution of illumination and nutrients into the plant growth chamber.

Finally, a temperature control device 13 is provided to regulate the temperature within the growth chamber. Such temperature control may be achieved by a variety of known means, including heating elements, various types of heaters, and thermal (infrared) radiation.

The plant biomass detection sensors 2b are used prior to illumination of the grow lights, to determine an optimum illumination pattern or light emission path of each grow light, as discussed in greater detail hereinafter. The biomass detection sensors 2b are used multiple times within a 24-hour period to capture the status of all plants within the chamber.

Plant monitoring within the plant growth chamber includes two-dimensional, point sensors, and may even include visual or magnetic resonance imaging for plants. Information acquired from these instruments includes spatial time series analysis (i.e., “droopy plant” time lapse photography, etc.) and includes two-dimensional and three-dimensional versions. Both macro and micro imaging spectroscopy, including reflective (multispectral, hyperspectral and texture analysis) fluorescent (multispectral, hyperspectral, and kinetic), RAMAN, thermal (active and passive) and luminescence analysis can be used. Non-imaging techniques may also be used, including photoacoustics and kinetic fluorescence.

Environmental monitoring 3 is accomplished using well known sensing devices which monitor environment conditions within the growth chamber. Monitored parameters include air temperature, relative humidity, moisture in the growth medium, CO2 levels, root temperature, micro-balances for measurement of evapotranspiration/biomass, trace gas levels, nutrients, soil (medium) water and Ph. As noted hereinabove, all of the latter information is input to the system 10, as depicted in FIG. 3, which uses it in the manner discussed previously, in order to make decisions regarding the input of water, chemicals and nutrients.

The environment within the growth chamber is regulated by the input of nutrients, chemicals, and water by the input apparatus 5, in a manner which is known to those skilled in the art. Control quantities include irrigation/fertilization, temperature control, humidity control, control of CO2 and other gases, and lighting control.

As noted previously, in order to promote rapid optimal plant growth within the growth chamber, the present invention also includes a precision lighting system.

The grow lights 4 illustrated in FIGS. 1 through 3, for example, include discrete wavelengths which are selected to accelerate plant growth. For example, grow lights may include light emitting diodes (LED's) which emit red, blue, or green light, and include ultraviolet, near infrared and visible light.

The grow lights work in conjunction with the output from the biomass detection sensors within the system. They are arranged in a grid array of lights located about the plant chamber, particularly above the plants, but optionally on the sides of the chamber as well. The biomass detection sensors determine where plant biomass is located within the chamber, and the latter information is used to turn on the grow lights in only those cells within the grid array that contain biomass. All the other grow lights (that is, those in cells having no biomass) remain off. This procedure minimizes the power consumed by the overall system, which is an important consideration in remotely situated cultivation programs.

The grow lights 4 are distributed within a matrix and include discrete wavelengths, which are individually operated, so that light of a desired wavelength or wavelengths may be distributed exclusively to those cells within the grid matrix of the plant growth chamber in which biomass is present. Accordingly, the grow light or lights for that cell are turned on, while all other grow lights remain off.

The grow lights may be selected to provide actinic light of 0 to 2000 micromoles per square meter per second. Spectral choices include red/blue dominant, approximately 10:1, with other colors. For fluorescence purposes, UV/red low level light is provided with temporal modulation. Finally, for reflectance purposes, white light LEDs are used, although near infrared may be used for night illumination and for the purpose of developing a normalized difference vegetation index.

In order to stimulate maximum plant growth, when the grow lights are activated, they emit energy under a high frequency modulation, for example, having a period within a range of hundreds of microseconds to a few tens of milliseconds. Such modulation of the light sources increases photosynthesis, thus reducing the amount of time and energy needed to grow the plant and reach maturity.

The system, as shown in FIG. 3, constitutes the brains of the growth chamber. It receives measurements and images from all sensors and analyzes that information to determine if a problem is occurring within the growth chamber. If so, it decides how to correct the problem and implements the correction. For example, if the carbon dioxide level within the growth chamber is too low for optimum growth, carbon dioxide is injected.

The system includes specific data on the particular plants which are being grown in the growth chamber. Such information may include, for example: optimal grow light schedules; fertilizer schedule and optimum carbon dioxide, humidity, temperature, and other environmental conditions within the growth chamber.

A hardware agnostic sensing and imaging platform coupled can be coupled to a database and management interface for means of sending manual or optimized control and automation set points to a BACnet or a Modbus gateway.

Examples of classification algorithms within the system include the normalized difference vegetation index and other standard vegetation indices, clustering algorithms, maximum likelihood classifications, e-cognition, etc., all of which are well known to those skilled in the art.

The inventive process begins with a set of data and progresses in four major steps:

1. Structure the data

2. Do the Learning

3. Process the results

4. Create recommendations

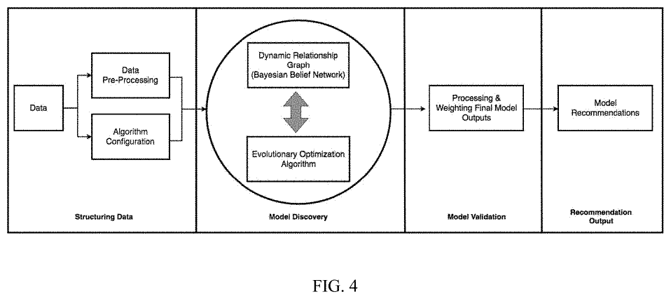

FIG. 4 is a block diagram illustrating the inventive process.

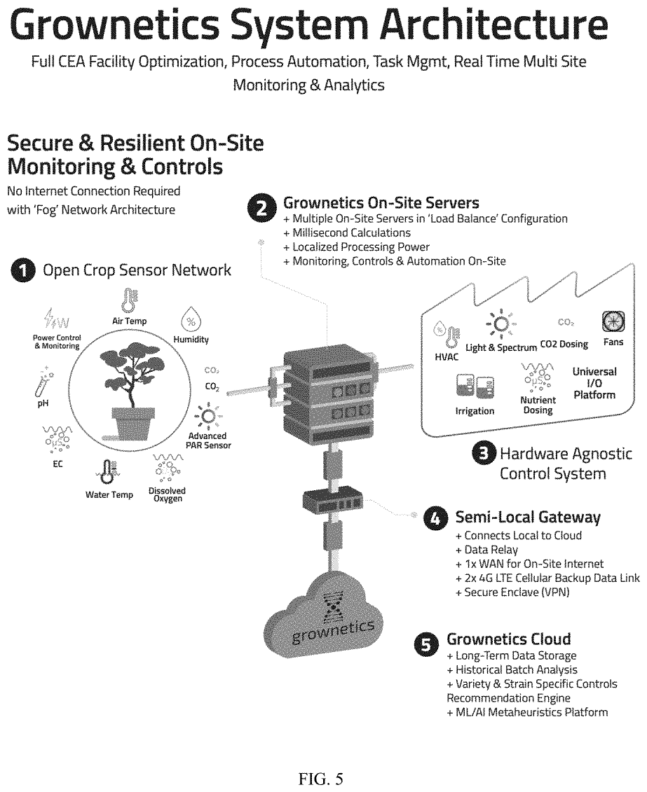

FIG. 5 is a schematic illustration of an example system architecture according to the invention.

Learning from the structured data can be accomplished using a variety of optimization routines, including but not limited to, Bayesian Optimization strategy, and N.E.A.T. ML (Neuroevolution of Augmenting Topologies) to learn from the output of optimization routine. Described in detail as one example is the Bayesian Optimization strategy. Baye's Rule describes the probability of an event based on prior knowledge of conditions that might be related to the event. This is called Bayesian Inference. If data is regarded as events, a network of dependencies known as a Bayesian Belief Network (BBN) can be built.

A Bayesian Belief Network is a Directed Acyclic Graph (DAG) whose edges represent conditional probabilistic dependencies. For example, suppose that the probability of wearing a jacket is based on the predicted weather and chance of precipitation and the chance of precipitation depends on the weather. A graphical relationship can be built.

This graph along with historical (time series) data can be used to calculate the probability of wearing a jacket given weather and chance of precipitation.

On the other hand, Bayesian optimization takes in data and iteratively searches for optimal parameters of a given function. If the function is unknown, an acquisition function is constructed and utilized in the optimization scheme.

Phoenics, developed by Harvard scientists, is an open-source software package which combines a probabilistic global optimization algorithm, combining ideas from Bayesian optimization with concepts from Bayesian kernel density estimation these two approaches to perform universal deep Bayesian Optimization. Phoenics uses the probability distributions from all possible Belief Network configurations to construct the acquisition function and perform proxy optimization. In short, the Bayesian Optimization routine learns from the output of the Belief Networks.

The invention is based on the premise that agricultural controls and productivity can be optimized using the aforementioned approach. For example, overall yield is affected in part by local environmental conditions such as carbon dioxide and temperature.

Accordingly, yield can be represented as a function of those two variables:

y(c,t)

Given time series data for these three variables, Phoenics runs through all possible Belief Network structures and averages the probability distributions given by each configuration. The average is written as:

pᵢ(x)

To construct the acquisition function, these averages are weighted by each observation of the yield function:

$$α ( x ) = \frac{{Σ}_{i} {p}_{i} ( x ) {y}_{i} + λ {p}_{n}}{{Σ}_{i} {p}_{i} ( x ) + {p}_{n}}$$

Here,
λ is the exploration/exploitation parameter in the Bayesian Optimizer
pₙ is the uniform probability distribution.

The acquisition function converges to the objective function for large sample sets.

A Bayesian Belief Network (BBN) is a graph that shows conditional dependencies between data. Bayesian Inference (among other statistical inference techniques) is used to infer certain aspects of the data, such as: optimal graph structure, latent/hidden variable approximation, hyperparameter/distribution estimation, etc.

An acquisition function based on the estimations from the BBN can be constructed. The acquisition function of a set of data contains statistical information relating to the data, and its optimization leads to the optimization of the variable the data is measuring. Optimization of the acquisition function is performed via any one of a plethora of optimization algorithms. Through use of BBNs and else, it is possible to produce operationally generic optimization algorithms for farming operations. BBNs and Bayesian optimization work in tandem to deliver statistically sound recommendations and discover optimized set points.

Together with the communication medium 11, the system 10 provides a system by which a person who is not located at the growth chamber can access all information on plant and environmental conditions within the growth chamber, for example, via the Internet and the world wide web, in a process known as “tele-horticulture.” The remote decision maker can interface with the system via a graphic user interface, a keyboard or other input/output device, and can provide information to the system as well as receive information from it. The remote decision maker can then override the system or resolve issues, to control any component within the growth chamber.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are claimed, it should be understood that compounds known and available in the art prior to Applicant's invention, including compounds for which an enabling disclosure is provided in the references cited herein, are not intended to be included in any composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A system for achieving optimized crop growth, comprising:
a) a growth chamber;
b) an environmental monitoring means for acquiring and monitoring data regarding environmental conditions within the growth chamber;
c) a resource control means for controlling resources applied to the growth chamber; and
d) a metaheuristics based optimizer system coupled to the environmental monitoring means for analyzing and evaluating crop growth conditions within the growth chamber, structuring data associated with the crop growth conditions, learning from the structured data using a routine to learn from the output of different machine learning strategies, and generating recommendations to optimize crop growing inputs, means to achieve optimized crop growth with minimum consumption of energy, labor, and resources while improving yield and quality;
wherein the metaheuristics based optimizer system controls and recommends resources in response to the crop growth information to achieve optimized plant growth, maximum yield, and minimized power consumption.

2. The resource control means of claim 1 further comprising a hardware agnostic sensing and imaging platform coupled to a database and management interface capable of sending manual or optimized control and automation set points to a BACnet or a Modbus gateway.
